(19) United States
(12) Patent Application Publication
(10) Pub. No.: US 2018/0196160 A1
(43) Pub. Date: Jul. 12, 2018

(54) APPARATUS AND METHOD FOR ANALYSIS OF GEOPHYSICAL LOGGING DATA USING GAMMA RAYS

(71) Applicant: Korea Institute Of Geoscience And Mineral Resources, Daejeon (KR)

(72) Inventors: Hyun Suk LEE, Daejeon (KR); Chul Woo RHEE, Daejeon (KR)

(73) Assignee: Korea Institute Of Geoscience And Mineral Resources, Daejeon (KR)

(21) Appl. No.: 15/740,627

(22) PCT Filed: Jul. 6, 2016
(86) PCT No.: PCT/KR2016/007334

§ 371 Date: Dec. 28, 2017

(30) Foreign Application Priority Data
Jul. 7, 2015 (KR) 10-2015-0096449

(51) Int. Cl. G01V 5/12; G01V 5/04

(52) U.S. Cl. CPC G01V 5/12; G01V 5/045

(57) ABSTRACT

The present disclosure relates to an apparatus and a method for analysis of geophysical logging data obtained by using gamma ray logging, so as to predict lithofacies of strata by analysis of geophysical logging data, for lithofacies across a wide area, on the basis of data analyzed using gamma ray logging. The present disclosure comprises: a gamma ray emission unit; a gamma ray transmission and reception unit; and a logging determination unit. Thus, the present disclosure can analyze geophysical logging data, for lithofacies across a wide area, on the basis of data analyzed obtained by using gamma ray logging, by clustering and patterning the results of the geophysical logging data only for significant strata, and can analyze strata with greater accuracy.

### TECHNICAL FIELD

The present disclosure relates to an apparatus and a method for analysis of geophysical logging data obtained by using gamma ray logging and, more particularly, to an apparatus and a method for analysis of geophysical logging data obtained by using gamma ray logging, the apparatus and method being configured to analyze geophysical logging data of lithofacies of strata in an area within a wide range based on data obtained by using gamma ray logging when estimating lithofacies of strata.

### BACKGROUND ART

A conventional method to cluster information on the lithofacies of strata according to a type and condition of the lithofacies of strata has been mostly performed by relying on an empirical judgement of few specialist geologists. Consequentially, such a method has shown limitations as a qualitative method because it is not based on quantitative numerical value. In many other areas, various methods have been attempted to cluster an object in an objective and automated manner.

In order to identify petrophysical characteristics of lithofacies of strata in a stratum, there is a method to form geophysical logging data by analyzing physicochemical properties of the stratum by inserting a device into a borehole after digging the borehole.

Among geophysical logging data, especially, properties reflecting petrophysical characteristics are different from each other depending on a structure, mineral composition of a rock, a sedimentary structure, a fluid in an air gap, etc. Therefore, various methods have been suggested to cluster a borehole logging section into geologically significant stratum units obtained by using a combination of properties of borehole logging data. A unit of each stratum that borehole logging data is clustered into according to a combination of constant property value is called an electrofacies. For classification of electrofacies for the borehole logging section, methods to statistically classify digitalized borehole logging data are divided in cluster analysis and discriminant analysis techniques. However, geophysical logging data for the above-stated stratum is heavily dependent on subjective interpretation depending on analyst's background knowledge, and therefore, objectivity of the results thereof is difficult to achieve. Particularly, for the analysis of geophysical logging data for a certain stratum, analysis is generally performed by using a printout or a terminal, thereby meeting with a limitation of requiring long working hours for analysis of the data.

In addition, geophysical logging analysis through statistical approaches currently being developed have been studied merely on numerical analysis simply based on statistics wherein no geological meanings are given to elements in the data. Furthermore, geophysical logging analysis through statistical approaches currently being developed has been actually performed for the analysis of a geophysical logging data of a single borehole.

In addition, up to now, analysis in a where a geologist directly analyzes geophysical logging data based on recorded data of a core has been performed, but analysis in where core data is understood and sedimentary environment is inferred based on the analysis results of a geophysical logging data has not been performed.

To resolve such a problem, as disclosed in Korean Patent No. 10-1148835 (cited invention), by yielding geophysical logging data for lithofacies of strata in an area in a wide range into results with high reliability based on a few core data, an oil sand reservoir estimation method is disclosed by using statistical analysis of geophysical logging data in estimating the lithofacies of strata.

However, since the cited invention analyzes data by using databased statistics in analyzing the data, and restores in a vertical resolution unit electrofacies, a degree of restoration may be changed depending on composition of a database. In addition, in restoring electrofacies, since both of significant and insignificant strata are used, accuracy may be decreased depending on composition of the strata. Accordingly, in restoring electrofacies, there is a problem depending on a database.

### DISCLOSURE

### Technical Problem

Therefore, the present disclosure is contrived to resolve problems of the related art as described above. An objective of the present disclosure is directed to providing an apparatus and a method for analysis of geophysical logging data obtained by using gamma ray logging, the apparatus and method being configured to analyze results of the geophysical logging data for lithofacies of strata in an area within a wide range based on data obtained by using gamma ray logging, by analyzing geophysical logging data only for significant strata through clustering and patterning the geophysical logging data for the significant strata, thus promoting efficiency of estimating lithofacies of strata.

In addition, the present disclosure is directed to providing an apparatus and a method for analysis of geophysical logging data obtained by using gamma ray logging, which can realize more precise analysis of strata by analyzing geophysical logging data through clustering, patterning, and formularizing of the geophysical logging data.

### Technical Solution

In order to accomplish the above object, an apparatus for analysis of geophysical logging data obtained by using gamma ray logging includes a gamma ray emission unit which emits gamma rays by nuclear transition of atomic nuclei, a gamma ray transmission and reception unit which allows the emitted gamma rays to penetrate through an object and receives the gamma rays, and a logging determination unit which receives information on waveforms and wavelengths of the gamma rays emitted by the gamma ray emission unit, and information from the transmission and reception unit following the penetration of the gamma rays through the object, and produces geophysical logging data for which the information on the speeds, waveforms and wavelengths of the received gamma rays has been analyzed.

The apparatus for analysis of geophysical logging data obtained by using gamma ray logging further includes an input unit which provides input means to adopt necessary data only among clustered geophysical logging data, a display unit which displays analyzed geophysical logging data, and a storage unit which stores the analyzed geophysical logging data in a set of table and graphical data.

The analyzed geophysical logging data are for clustering strata by using the information on the speeds, waveforms, and wavelengths of the received gamma rays, determining a stratum classified by the clustering as a prescribed pattern, and formularizing the pattern.

The formularizing of the pattern determines any one of a dispersion and a straight line, wherein the dispersion is a state that, by calculating a standard deviation within a cluster, data between a start point and an end point are scattered and the straight line is a state that, by calculating the standard deviation within the cluster, the data between the start point and the end point are on a straight line.

The determining of the pattern determines any one among a cylindrical pattern that has a sharp top, a base, and a flat type block shape, a funnel pattern that is a type with sizes of particles being increased gradually and having a sharp top, a bell pattern that is a type with sizes of particles being decreased gradually and having a sharp top, a symmetrical pattern with a degree of coarseness of particles forming a shape that sands flow down, and a serrated pattern that is a type with a degree of coarseness of particles forming an irregular serrated shape.

A method for analysis of geophysical logging data obtained by using gamma ray logging to accomplish an objective as above with a gamma ray emission unit emitting gamma rays by nuclear transition of atomic nuclei, a gamma ray transmission and reception unit allowing the emitted gamma rays to penetrate through an object and receiving the gamma rays, and a logging determination unit producing geophysical logging data and analyzing by using the geophysical logging data comprises: receiving data of gamma rays from the gamma ray transmission and reception unit, producing geophysical logging data obtained using gamma ray logging, analyzing the geophysical logging data by using a sequential K-means clustering algorithm, displaying the analyzed geophysical logging data in a form of tables and graphs, and storing the analyzed geophysical logging data.

The analyzing of the geophysical logging data includes patterning a style of the geophysical logging data, and formularizing the patterned geophysical logging data.

The formularizing of the patterned geophysical logging data determines any one of a dispersion and a straight line, wherein the dispersion is a state that, by calculating a standard deviation within a cluster, data between a start point and an end point are scattered, and the straight line is a state that, by calculating the standard deviation within the cluster, the data between the start point and the end point are on a straight line.

The patterning the style of the data determines any one among a cylindrical pattern that has a sharp top, a base, and a flat type block shape, a funnel pattern that is a type with sizes of particles being increased gradually and having a sharp top, a bell pattern that is a type with sizes of particles being decreased gradually and having a sharp top, a symmetrical pattern with a degree of coarseness of particles forming a shape wherein sand flows down, and a serrated pattern that is a type with a degree of coarseness of particles forming an irregular serrated shape.

### Advantageous Effects

An apparatus and a method for analysis of geophysical logging data obtained by using gamma ray logging according to the present disclosure has an effect of promoting efficiency of estimating lithofacies of strata by providing the apparatus and the method to be configured to analyze results of the geophysical logging data for lithofacies of strata in an area within a wide range obtained based on data obtained by using gamma ray logging, and by analyzing geophysical logging data only for significant strata through clustering and patterning the geophysical logging data for the significant strata.

In addition, an apparatus and a method for analysis of geophysical logging data obtained by using gamma ray logging according to the present disclosure has an effect of realizing more precise analysis of strata by analyzing geophysical logging data through clustering and patterning of the geophysical logging data.

### DESCRIPTION OF DRAWINGS

FIG. 1 is a block diagram illustrating schematically components of an apparatus for analysis of geophysical logging data obtained by using gamma ray logging according to an embodiment of the present disclosure.

FIG. 2 is a flowchart illustrating a method of analysis of geophysical logging data obtained by using gamma ray logging according to an embodiment of the present disclosure.

FIG. 3 is a flowchart illustrating a process of analyzing data of FIG. 2 according to an embodiment of the present disclosure.

FIGS. 4a to 4e are views illustrating types of patterning of FIG. 3 according to an embodiment of the present disclosure.

FIGS. 5a to 5d are views illustrating the analysis results in a table and graphs for the geophysical logging data according to an embodiment of the present disclosure.

### BEST MODE

An exemplary embodiments according to a concept of the present disclosure may be modified in various ways and have many types, and some specific embodiments will be illustrated in drawings and described in detail in this specification or an application of the specification. However, this is not intended to limit embodiments according to a concept of the present disclosure to a specific disclosure form and the embodiments should be understood to include all modifications, equivalents or substitutes that are included in a concept and technical scope of the present disclosure.

When it is described that a component is “coupled” or “connected” to another component, it should be understood that the component is “coupled” or “connected” to another component directly or via other component therebetween. On the other hand, when it is described that a component is “directly coupled” or “directly connected” to another component, it should be understood that no other component exists therebetween. Other expressions describing relationship between components such as “between . . . ” and “directly between . . . ” or “neighboring to . . . ” and “directly neighboring to . . . ” should be understood in the same manner.

Terms used in the present specification are merely to describe an exemplary embodiment and are not intended to limit the present description. An expression in a singular, unless meaning thereof is clearly different in the context, includes the case of plural. Terms used in the present specification such as “include” or “have or has” should be understood to designate existence of characteristics, a numeral, a step, an action, a component, parts or combination thereof, but not to exclude in advance existence or possibility of addition of characteristics, a numeral, a step, an action, a component, parts, or combination thereof.

Hereinafter, an exemplary embodiment of the present disclosure will be described in detail with reference to the accompanying drawings. In the following description of the present disclosure, detailed descriptions of known functions and components incorporated herein will be omitted when it may make the subject matter of the present disclosure unclear.

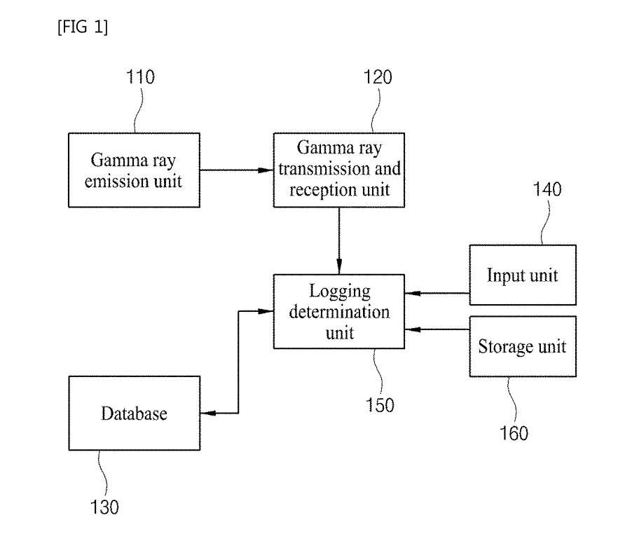

Hereinafter, the present disclosure will be described in detail with reference to the accompanying drawings illustrating an embodiment of the present disclosure. FIG. 1 is a block diagram illustrating schematically components of an apparatus for analysis of geophysical logging data obtained by using gamma ray logging according to an embodiment of the present disclosure. Referring to FIG. 1, the present disclosure is composed of a gamma ray emission unit 110, a gamma ray transmission and reception unit 120, an input unit 140, a logging determination unit 150, and a storage unit 160.

The gamma ray emission unit 110 emits gamma rays by nuclear transition of atomic nuclei of a Co-60.

The gamma ray transmission and reception unit 120 allows the emitted gamma rays to penetrate an object, for example, a borehole or strata, and receives the gamma rays.

The logging determination unit 150 receives information such as wavelengths of the gamma rays emitted by the gamma ray emission unit 110, and information from the transmission and reception unit following the penetration of the gamma rays through the object and stores such information in the storage unit 160. The logging determination unit 150 produces geophysical logging data by analyzing information on speeds, waveforms, and wavelengths of the received gamma rays.

The logging determination unit 150 retrieves data from the geophysical logging data and performs clustering of retrieved data by automatic analysis. Clustering is produced by using a sequential K-means clustering algorithm and calculated in a manner such that a variance of each cluster and a distance is minimized, wherein the variance (V) can be obtained by using an equation 1 as in the following.

$$V = {\sum }_{i = 1}^{k} {\sum }_{j ⋐ {S}_{i}} {\vert {x}_{j} - {μ}_{i} \vert}^{2} , \qquad [ Equation 1 ]$$

where V represents the variance between the cluster and distance, μᵢ a center of an i-th cluster, Sᵢ a set of points belonging to the cluster, and xⱼ represents a distance of a location of j-th borehole logging.

An operator may adopt necessary data only through the input unit 140 from geophysical logging data clustered like this. That is, the input unit 140 allows the operator to adopt the data as needed from the clustered numerical and graphical data.

The display unit displays analysis results of geophysical logging data in a form of tables and graphs. Meanwhile, the operator can make the logging determination unit 150 display the relevant analysis results by entering a command to display relevant analysis results through the input unit 140 as necessary.

The storage unit 160 stores the geophysical logging data analyzed like this as data and the data can be stored in the same form of stable and graphs as displayed by the display unit. Analysis results of the geophysical logging data can be stored in the form of tables and graphs at the storage unit 160. Calculated analysis result values are entered in a form of numerals into the tables.

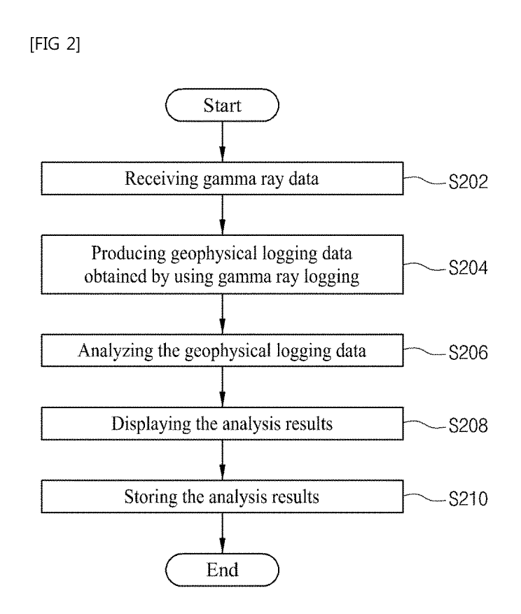

FIG. 2 is a flow chart illustrating a method of analysis of geophysical logging data obtained by using gamma ray logging according to an embodiment of the present disclosure. Referring to FIG. 2, at step S202, the logging determination unit 150 receives gamma rays through the gamma ray transmission and reception unit 120. At step S204, the logging determination unit 150 produces geophysical logging data obtained by using gamma ray logging. Gamma ray data is information on speed, waveform, and wavelength of the received gamma rays being received and the logging determination unit 150 produces geophysical logging data obtained by using gamma ray logging.

At step S206, the logging determination unit 150 analyzes the geophysical logging data. Analysis of geophysical logging data that the logging determination unit 150 performs is carried out by using a sequential K-means clustering algorithm.

At step S208, the logging determination unit 150 displays the analyzed geophysical logging data in a form of tables and graphs through the display unit.

At step S210, the logging determination unit 150 stores the geophysical logging data analyzed like this in the storage unit 160. At this time, data stored in the storage unit 160 can be stored in a form of tables and graphs. Analysis results like these are stored such that they can be verified afterwards. In addition, stored data should be a set of files to be verifiable by using different tool and compatibility thereof should be maintained.

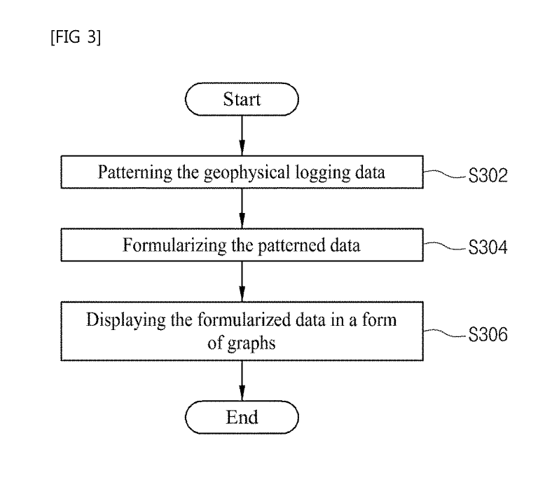

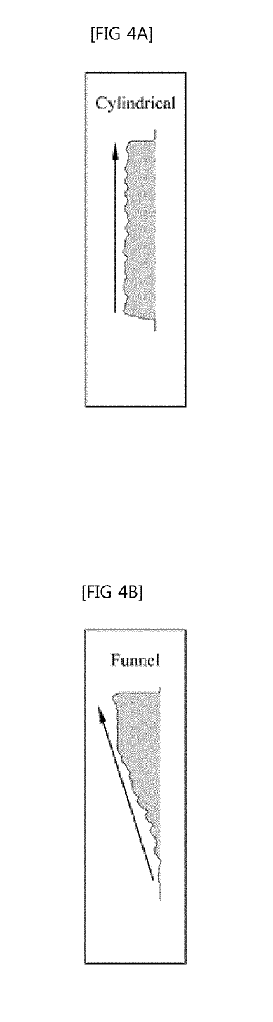

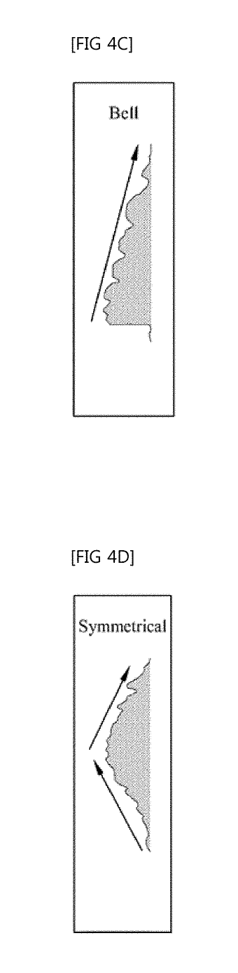

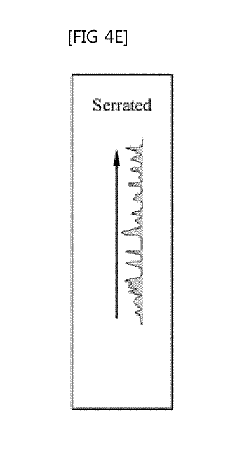

FIG. 3 is a flow chart illustrating a process of analyzing data of FIG. 2 according to an embodiment of the present disclosure, FIGS. 4a to 4e are views illustrating types of patterning of FIG. 3 according to an embodiment of the present disclosure. Referring to FIG. 3 and FIGS. 4a to 4e, at step S302, the logging determination unit 150 performs patterning of style of geophysical logging data. Patterning is performed on the basis of the analyst's experience, and data having the same type as FIGS. 4a to 4e are meaningful. This will be described referring to FIGS. 4a to 4e.

Analysis results can be expressed as FIG. 4a to FIG. 4e. FIG. 4a is a view illustrating that a classified cluster having particles with a sharp top and a base or shaped as a flat type block is classified as a cylindrical pattern. FIG. 4b is a view illustrating that a type with a degree of coarseness of particles being increased gradually and having a sharp top is classified as a funnel pattern. FIG. 4c is a view illustrating that a type with a degree of coarseness of particles being decreased gradually and having a sharp top is classified as a bell pattern. FIG. 4d is a view illustrating that a degree of coarseness of particles forming a shape that sands flow down is classified as a symmetrical pattern. FIG. 4e is a view illustrating that a degree of coarseness of particles forming an irregular serrated shape is classified as a serrated pattern.

Referring to FIG. 3, at step S304, the logging determination unit 150 mathematically formularizes a patterned style. Classifying like this is set by the operator and classifying is performed as follows by mathematical equation to analyze the patterned style. First, a standard deviation is calculated for data with mean value as a reference within a single cluster. By calculating the standard deviation, a state that many of data are deviated from a straight line or some of data are greatly deviated from a straight line can be classified as dispersion as data between a start point and an end point are scattered. By calculating the standard deviation, when data between the start point and the end point are on a straight line and points are not deviated much from a relevant straight line, this state can be classified as a straight line. From this, states can be classified as in the Table 1 below.

TABLE 1

| Straight | | |
|---|---|---|
| line/Dispersion | Increase/Decrease | Pattern |
| 1 (Straight line) | 1 (Increase) | 3 (funnel) |
| | 2 (Maintenance) | 2 (cylindrical) |
| | | 4 (symmetrical) |
| | 3 (Decrease) | 1 (bell) |
| 2 (Dispersion) | 1 (Increase) | 3 (funnel) |
| | 2 (Maintenance) | 2 (cylindrical) |
| | | 4 (symmetrical) |
| | 3 (Decrease) | 1 (bell) |

Next, a patterned style is formularized and classified as a straight line when it is within a predetermined range. However, since it is difficult to define the predetermined range in advance, the operator is allowed to change the range through the input unit 140.

In addition, within a single cluster, by taking a start point or an end point as a reference, a trend of increase or decrease of numeral values is determined. At this time, because a start point or an end point might have been a type of data overly stuck out due to a noise, therefore, a reference point may be generated by averaging a certain number of points from the start point or the end point, or by calibrating by a typical start point or an end point by using before-and-after data of a cluster. In the case of neither increase nor decrease, it can be determined as a straight line, and a reference of a certain numeral value is necessary to determine increase/decrease and a straight line. A reference point for an increase and a decrease can be set by the operator through the input unit 140.

At step S306, the logging determination unit 150 can also display the analysis results displayed in a form of numerals in a form of graph. Identifying analysis results in the form of numerals is difficult. Therefore, by displaying analysis results in the form of graphs, analysis results can be easily identified. A graph is displayed by grouping the results depicted in mathematical equation as described above whereby the operator can recognize easily.

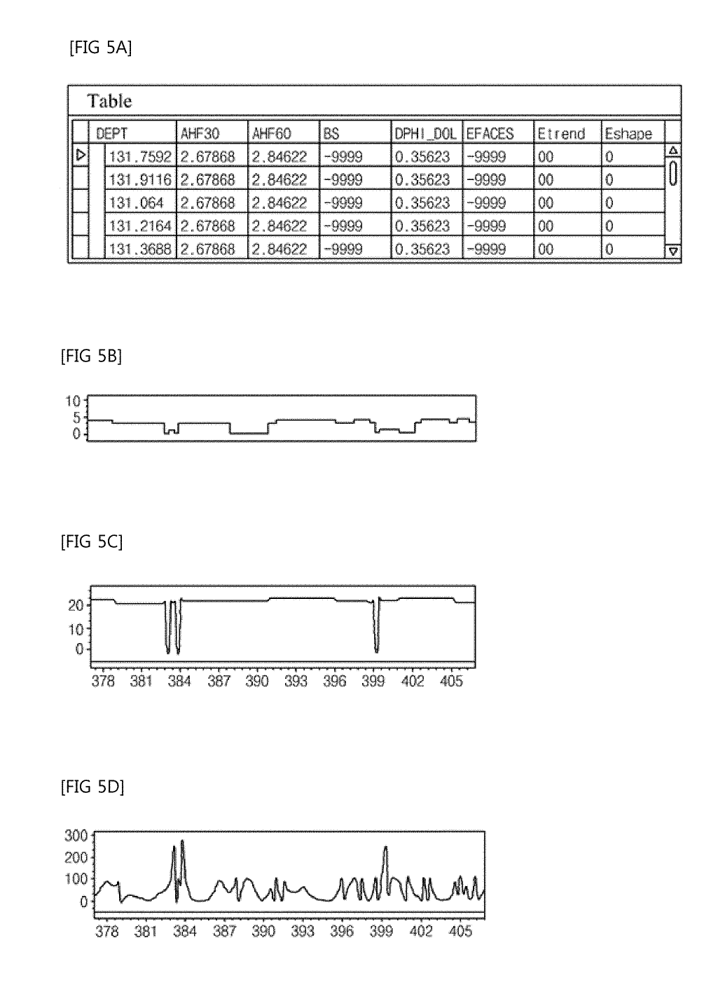

FIGS. 5a to 5d are views illustrating a table and graphs showing the analysis results for the geophysical logging data according to an embodiment of the present disclosure. Referring to FIGS. 5a to 5d, FIG. 5a is a view illustrating the analysis result values for the geophysical logging data according to an embodiment of the present disclosure in a form of the table. Referring to FIG. 5a, it is a table being set in the state that clusterings are shown as five in number, a standard deviation reference for determination of a straight line or dispersion is 10, and a reference for determination of an increase or a decrease is 15.

FIG. 5b is a graph illustrating the clustering results. As illustrated in FIG. 5a, since five clusters are grouped, FIG. 5b can be illustrated with zero to four clusters. Forming a unit block while a value is maintained on the graph is classified as one cluster. That is, one layer being formed can be easily identified over the range from where it starts to where it ends.

When analysis progresses, it is performed by the single cluster. Therefore the operator can confirm and set the range of the cluster.

FIG. 5c is a graph illustrating a type/pattern/class/category of analyzed data. In FIG. 5c, values between 21 and 23 are shown as disclosed in Table 1, wherein 21 means a straight linear increase, 22 means a straight linear maintenance, and 23 means a straight linear decrease. The fact that major data are represented as a straight line may be understood that no part of relevant data has vibration values or standard deviation value taken as a reference is so large, thereby being unable to identify the dispersion. Accordingly, in this case, it is necessary for the operator to get more accurate analysis results through iteration by reducing standard deviation value until desired results are produced.

FIG. 5d illustrates raw data that are the data before analysis is performed. The operator can make a more accurate determination in reference with the raw data in FIG. 5d. That is, the operator can use the raw data as bases for the determination.

An exemplary embodiments according to a concept of the present disclosure may be modified in various ways and have many types, some specific embodiments were illustrated in drawings and described in detail in this specification. However, this is not intended to limit embodiments according to a concept of the present disclosure to a specific disclosure form and the embodiments should be understood to include all modifications, equivalents or substitutes that are included in a concept and technical scope of the present disclosure.

1. An apparatus for analysis of geophysical logging data obtained by using gamma ray logging, the apparatus comprising:
a gamma ray emission unit emitting gamma rays by nuclear transition of atomic nuclei;
a gamma ray transmission and reception unit allowing the emitted gamma rays to penetrate through an object and receiving the gamma rays; and
a logging determination unit receiving information on waveforms and wavelengths of the gamma rays emitted by the gamma ray emission unit, and information from the transmission and reception unit following the penetration of the gamma rays through the object, and producing geophysical logging data for which the information on the speeds, waveforms, and wavelengths of the received gamma rays has been analyzed.

2. The apparatus of claim 1, further comprising:
an input unit providing input means to adopt necessary data only among clustered geophysical logging data;
a display unit displaying analyzed geophysical logging data; and
a storage unit storing the analyzed geophysical logging data in a table and a graph.

3. The apparatus of claim 1, wherein the analyzed geophysical logging data are for clustering strata by using the information on the speeds, waveforms, and wavelengths of the received gamma rays, determining a stratum classified by the clustering as a prescribed pattern, and formularizing the pattern.

4. The apparatus of claim 3, wherein the formularizing the pattern determines any one of a dispersion and a straight line, wherein the dispersion is a state that, by calculating a standard deviation within a cluster, data between a start point and an end point are scattered, and the straight line is a state that, by calculating the standard deviation within the cluster, the data between the start point and the end point are on a straight line.

5. The apparatus of claim 3, wherein the determining the pattern determines any one among: a cylindrical pattern that has a sharp top, a base, and a flat type block shape; a funnel pattern that is a type with sizes of particles being increased gradually and having a sharp top; a bell pattern that is a type with sizes of particles being decreased gradually and having a sharp top; a symmetrical pattern with a degree of coarseness of particles forming a shape that sands flow down; and a serrated pattern that is a type with a degree of coarseness of particles forming an irregular serrated shape.

6. A method for analysis of geophysical logging data obtained by using gamma ray logging with
a gamma ray emission unit emitting gamma rays by nuclear transition of atomic nuclei,
a gamma ray transmission and reception unit allowing the emitted gamma rays to penetrate through an object and receiving the gamma rays to be received, and
a logging determination unit producing geophysical logging data and analyzing the geophysical logging data, the method comprising:
receiving data of gamma rays from the gamma ray transmission and reception unit;
producing geophysical logging data by using the data of gamma rays;
analyzing the geophysical logging data by using a sequential K-means clustering algorithm;
displaying the analyzed geophysical logging data in a form of tables and graphs; and
storing the analyzed geophysical logging data.

7. The method of claim 6, wherein the analyzing the geophysical logging data includes:
patterning a style of the geophysical logging data; and
formularizing the patterned geophysical logging data.

8. The method of claim 7, wherein the formularizing the patterned geophysical logging data determines any one of a dispersion and a straight line, wherein
the dispersion is a state that, by calculating a standard deviation within a cluster, data between a start point and an end point are scattered, and
the straight line is a state that, by calculating the standard deviation within the cluster, the data between the start point and the end point are on a straight line.

9. The method of claim 7, wherein the patterning the style of the data determines any one among: a cylindrical pattern that has a sharp top, a base, and a flat type block shape; a funnel pattern that is a type with sizes of particles being increased gradually and having a sharp top; a bell pattern that is a type with sizes of particles being decreased gradually and having a sharp top; a symmetrical pattern with a degree of coarseness of particles forming a shape that sands flow down; and a serrated pattern that is a type with a degree of coarseness of particles forming an irregular serrated shape.
